(19) United States
(12) Patent Application Publication
(10) Pub. No.: US 2024/0150589 A1
(43) Pub. Date: May 9, 2024

(54) SELF-PRIMING ANTIBACTERIAL, NON-STICK COATING FOR COOKWARE, UTENSILS, AND BLADES

(71) Applicant: Vinay G Advani, Hoboken, NJ (US)

(72) Inventor: Vinay G Advani, Hoboken, NJ (US)

(21) Appl. No.: 18/053,833

(22) Filed: Nov. 9, 2022

(51) Int. Cl. C09D 5/14; A47J 36/02; C09D 5/00; C09D 7/61

(52) U.S. Cl. CPC C09D 5/14; A47J 36/025; C09D 5/002; C09D 7/61

(57) ABSTRACT

An antibacterial non-stick coating composition that is combined with a primer and directly applied to a metal surface. The composition essentially comprising Silica sol, Silane, Pigment, Water, SiO₂, acetic acid, an antibacterial agent and Ti in such concentration and process that it results in a single, self-priming composition used to coat a surface in one application to the surface of articles and implements including but not limited to ancillary cookware and utensils including food storage vessels and containers, flatware, cutlery and components thereof such as blades, tools and items susceptible to having materials stick and/or support growth of bacteria.

### I. BACKGROUND

### A. Field of Invention

The present invention generally relates to cookware, utensils and other devices that benefit from a non-stick surface. More particularly, the invention is a self-priming, non-stick coating mixture that has antibacterial properties.

### B. Description of the Related Art

The technology of an antibacterial, non-stick surface on cookware, utensils and other devices that benefit from a non-stick surface or an antibacterial property, typically involves separate applications of different composition coatings on a substrate, for example, an undercoat primer to adhere to the substrate, an overcoat to provide a non-stick coating or finish and an antibacterial agent.

The foregoing process requiring multiple steps and applications thereof causes a reduction in productivity and inconsistency in applications. There is a need in the industry to improve the coating process so a product and/or surface may be treated, coated or finished in a single application, and requires therefore a single composition that is self-priming and exhibits non-stick, antibacterial properties

### II. SUMMARY

The present invention resolves the industry need and is a single composition that resolves as a non-stick coating mixture with antibacterial properties to protect surfaces of cookware and utensils against the growth of odor and stain-causing bacteria and is self-priming. The composition of the invention may be disposed in single application, eliminating multiple coatings of different compositions.

In furtherance of having usefulness for cookware and utensils, the inventor has discovered the underlying composition also benefits a variety of articles and implements including but not limited to ancillary cookware and utensils including food storage vessels and containers, flatware, cutlery and components thereof such as blades, tools and items susceptible to having materials stick and/or support growth of bacteria.

### IV. DETAILED DESCRIPTION OF THE INVENTION

It has been found, in accordance with this invention, that an antibacterial non-stick coating composition can be combined with a primer and directly applied to a metal surface, the combination of which adheres very well to metallic substrates (e.g., steel, galvanized steel, stainless steel, copper, titanium, cast iron, aluminum, aluminum alloys and multilayer substrates) and may be applied in a single composition with minimal processing.

In an embodiment, the claimed composition essentially comprises Silica sol, Silane, pigment, Water, SiO₂, acetic acid, an antibacterial agent and Ti in the following range of concentrations,
Silica sol, about 30-35%
Silane, about 20-35%
Pigment, about 20-25%
Water, about 10-15%
SiO₂, about 15-20%
Acetic Acid, about 1-5%
Antibacterial agent, about 1-5%
Ti, about 1-5%.

As referenced herein, Silica sol is a metal surface treatment agent, which in an embodiment such composition includes aqueous, solvent-free, colloidal solutions of amorphous Silicon dioxide, with particle sizes in the range of 5 nm to 100 nm. Silane is, as a precursor to silicon, an effective water repellent and acts as a binder. It is known pigment combined with silanes has been found to exhibit strong leafing that can increase luster.

The composition in accordance with an embodiment of the present invention may contain one or more pigments for example mineral(s) including micronized or submicronized pigments, inorganic pigments that can include an agent that contains titanium (Ti). The antibacterial agent is silver ion powder, for example from silver-magnesium-aluminum phosphate complex at about 1.6%.

The antibacterial agent includes in an embodiment, anti-microbial particles such as silver or silver compounds and are applied to the mixture to reduce and kill bacteria and other potential germs that may be located on a surface of cookware, utensils, food storage vessels, containers cutting blades and the like.

The steps in preparing the foregoing composition include,
(a) Combining to blend part Ti, part SiO₂ and part Silane in a roll drum with parts water and parts acetic acid and rolled for at least about 1-4 hours at a temperature range of 20-25° C., or until there is insignificant or no sediment; then,
(b) Adding an antibacterial agent, for example, silver ion powder by means of an Ultrasonic Dispersion Machine and rolling same for at least about 8-12 hours at 110 rpm. and around 20-25° C.; then,
(c) Combining pigment, a binder derived from a Silane and optional admixture catalyst of silicon being formed by powder (e.g., crystalline or micronized SiO₂) to liquid (amorphous, Silica sol) ration of about 1:1.3 and adding same to (b) and rolled at 100-120 rpm. for about 5-10 minutes at 20-25° C.; and then,
(d) Filtering the foregoing by means that include a mesh, namely in the range of about a 300-mesh screen (about 44 um or about 0.0013 in.).

The inventors applied the composition claimed herein to cookware and utensils using the following steps,
(a) Preheating the composition to about 50-70° C. and dispensing by use of a fixed air pressure gun; then,
(b) Drying by means of heat drying, for example a conveyor assembly oven line in the range of about 80-150° C. for about 10-20 min.; then,
(c) Curing by sinter in a conveyor oven in the range of about 260-290° C. for about 15-20 min. and cooling.

The inventors have discovered that a satisfactory range of thickness for the composition to be sprayed is about 12-18 μm. for cookware for example, pots and pans, or about 8-10 μm. for utensils including cutlery and household blades.

Overall results are achieved in best practices of ensuring the substrate is combined effectively with the claimed composition is by friction washing, roughening, sandblasting, abrading and/or otherwise roughening the surface thereof that supports a better binding surface and removes contaminants or various other materials that may affect the integrity of the claimed composition. A roughened surface can thereafter be further cleaned by ultrasonic treatment as part of or in replacement of an aqueous or alkali wash.

Having thus described the invention, what is claimed as new and desired to be secured by Letters Patent is:

What is claimed is:

1. A self-priming, non-stick, antibacterial composition that comprises, Silica sol, in the range of about 30-35%, Silane, in the range of about 20-35%, Water, in the range of about 10-15%, SiO₂, in the range of about 15-20%, and an Antibacterial agent, in the range of about 1-5%.

2. A self-priming, non-stick, antibacterial composition that comprises, as claimed in claim 1 further comprising Pigment, in the range of about 20-25%.

3. A self-priming, non-stick, antibacterial composition that comprises, as claimed in claim 1 further comprising Acetic Acid, in the range of about 1-5%.

4. A self-priming, non-stick, antibacterial composition that comprises, as claimed in claim 1 further comprising and Ti, in the range of about 1-5%.

5. A method of preparing the composition according to claim 1 that includes the steps of,
combining Ti, SiO₂ and Silane and rolling for at least about 1-4 hours at a temperature range of 20-25° C.;
adding an antibacterial agent by means of an Ultrasonic Dispersion Machine and rolling same for at least about 8-12 hours at 110 rpm;
combining pigment, a binder derived from a Silane and admixture catalyst of silicon for about 5-10 minutes at 20-25° C.; and,
filtering the foregoing by means that include a mesh.

6. The method of claim 5 whereby water and acetic acid are combined with Ti, SiO₂ and Silane before rolling for at least about 1-4 hours at a temperature range of 20-25° C.

7. The method of claim 5 whereby the antibacterial agent is silver ion powder.

8. The method of claim 5 whereby the admixture catalyst of silicon consists of powder (crystalline or micronized SiO₂) to liquid (amorphous, Silica sol) in the ration of about 1:1.3.

9. An article selected from the group consisting cookware, utensils, food storage vessels, food containers, flatware, cutlery, blades, household tools comprising a surface coating consisting of the composition in claim 1.
